(19) United States
(12) Patent Application Publication
(10) Pub. No.: US 2022/0140678 A1
(43) Pub. Date: May 5, 2022

(54) ROTOR OF ROTARY ELECTRIC MACHINE AND ROTARY ELECTRIC MACHINE

(71) Applicant: HONDA MOTOR CO., LTD., Tokyo (JP)

(72) Inventor: Yoshihisa Kubota, Saitama (JP)

(73) Assignee: HONDA MOTOR CO., LTD., Tokyo (JP)

(21) Appl. No.: 17/511,815

(22) Filed: Oct. 27, 2021

(30) Foreign Application Priority Data
Oct. 29, 2020 (JP) 2020-181543

(51) Int. Cl. H02K 1/27; H02K 21/14

(52) U.S. Cl. CPC H02K 1/2766; H02K 21/14

(57) ABSTRACT

A rotor of a rotary electric machine includes a rotor core, and a ring member. The rotor core is fastened and fixed to the ring member. The outer circumferential surface of the rotor coreincludes a groove portion which is recessed radially inward at a position overlapping the q-axis in the circumferential direction, and a protruding portion which protrudes radially outward from the groove portion. The protruding portion is provided with a pair of flange portions which protrude toward the one side and the other side in the circumferential direction from a base end portion connected to the groove portion. An outer circumferential surface of a tip end portion of the protruding portion and outer circumferential surface of the pair of flange portions have an arc shape having the same center and the same diameter as the outer circumferential surface of the rotor core.

### CROSS-REFERENCE TO RELATED APPLICATIONS

This application is based on and claims priority under 35 USC 119 from Japanese Patent Application No. 2020-181543 filed on Oct. 29, 2020.

### TECHNICAL FIELD

The present disclosure relates to a rotor of a rotary electric machine and a rotary electric machine mounted on an electric vehicle or the like.

### BACKGROUND ART

In recent years, electric vehicles such as hybrid vehicles, battery-driven vehicles, and fuel cell vehicles have become widespread, and rotary electric machines such as motors and generators are mounted on such electric vehicles. As one of the rotary electric machines mounted on the electric vehicles, there has been known an interior permanent magnet (IPM) type rotary electric machine in which a plurality of permanent magnets are arranged at predetermined intervals in a circumferential direction inside a rotor core.

With the widespread of electric vehicles, a rotary electric machine mounted on an electric vehicle is further required to have improved output performance, in the case of the IPM type rotary electric machine, in order to improve output performance, it is effective to arrange the plurality of permanent magnets arranged inside the rotor core as far on a radially outer side of the rotor core as possible, and to reduce thickness of a connection rib formed between a magnet insertion hole and an outer circumferential surface of the rotor core.

However, if the connection rib has reduced thickness, stress concentrates on the connection rib when the rotor core receives a radially outward centrifugal load from the permanent magnet due to a centrifugal force of the permanent magnet during rotation of the rotor, the rotor core, particularly the connection rib, is likely to be deformed radially outward, and thus there is a limit to arranging the permanent magnet on the radially outer side of the rotor core and reducing thickness of the connection rib.

Therefore, for example, JP-A-2016-100955 discloses a rotor of a rotary electric machine including: a rotor core which is formed with a magnet insertion hole where a permanent magnet is inserted and a ring member having a substantially annular shape which surrounds an outer circumferential surface of the rotor core, and the rotor core is fastened and fixed to the ring member. According to the rotor of a rotary electric machine described in JP-A-2016-100955, since the outer circumferential surface of the rotor core is surrounded by the ring member, the rotor core, particularly a connection rib, can be prevented from being deformed radially outward even when the rotor core receives a centrifugal force load during rotation of the rotor.

In addition, for example, JP-A-2017-163730 discloses a rotor of a rotary electric machine including a rotor core which has a substantially annular shape in which a plurality of magnetic pole portions are formed at predetermined intervals in a circumferential direction. When a central axis of each magnetic pole portion is referred to as a d-axis while an axis separated from the d-axis by an electric angle of 90 degrees is referred to as a q-axis, a groove portion which is recessed radially inward and extends in an axial direction is provided in an outer circumferential surface of the rotor core at a position overlapping the q-axis in the circumferential direction. According to the rotor of a rotary electric machine described in JP-A-2017-163730, a connection rib formed between a circumferential end portion of a magnet insertion hole and the outer circumferential surface of the rotor core has reduced thickness due to formation of the groove portion.

However, according to the rotor of a rotary electric machine described in JP-A-2017-163730, although the connection rib formed between the circumferential end portion of the magnet insertion hole and the outer circumferential surface of the rotor core has reduced thickness, a gap in a radial direction between the rotor core and a stator is increased in the groove portion which serves as a q-axis magnetic path, and magnetic resistance of the q-axis magnetic path is increased as the gap in the radial direction between the rotor core and the stator is increased, so that a q-axis magnetic flux may be decreased and thus output torque of the rotary electric machine may be decreased.

In addition, when the invention described in JP-A-2016-100955 is applied to the invention described in JP-A-2017-163730, the outer circumferential surface of the rotor core is provided with the groove portion which is recessed radially inward and extends in the axial direction at the position overlapping the q-axis in the circumferential direction. When the rotor core whose connection rib has reduced thickness as compared with that of the invention described in JP-A-2016-100955 is fastened and fixed to the substantially annular-shaped ring member, stress may be concentrated on a circumferential end portion of the groove portion due to a fastening load received by the rotor core from the ring member.

### SUMMARY OF INVENTION

The present disclosure provides a rotor of a rotary electric machine and a rotary electric machine capable of preventing a decrease in output torque of the rotary electric machine and reducing concentration of stress on a specific portion of a rotor core.

The present invention provides a rotor of a rotary electric machine including:

a rotor core having a substantially annular shape in which a plurality of magnetic pole portions are formed at predetermined intervals in a circumferential direction; and

a ring member having a substantially annular shape and covering an outer circumferential surface of the rotor core, in which:

each of the plurality of magnetic pole portions includes at least one magnet insertion hole which penetrates the rotor core in an axial direction, and a permanent magnet which is inserted into the magnet insertion hole;

the rotor core is fastened and fixed to the ring member;

a central axis of each of the plurality of magnetic pole portions is a d-axis;

an axis which is separated from the d-axis by an electric angle of 90 degrees is a q-axis; and

when viewed from the axial direction:
the magnet insertion hole provided in each of the plurality of magnetic pole portions includes:
an outer-diameter-side wall surface which extends in the circumferential direction;
an inner-diameter-side wall surface which extends in the circumferential direction and faces the outer-diameter-side wall surface on a radially inner side;
a first end portion which connects an end portion of the outer-diameter-side wall surface on one side in the circumferential direction and an end portion of the inner-diameter-side wall surface on the one side in the circumferential direction; and
a second end portion which connects an end portion of the outer-diameter-side wall surface on the other side in the circumferential direction and an end portion of the inner-diameter-side wall surface on the other side in the circumferential direction;

the outer circumferential surface of the rotor core includes:
a groove portion which is recessed radially inward and extends in the axial direction at a position overlapping the q-axis in the circumferential direction; and
a protruding portion which protrudes radially outward from the groove portion at a position overlapping the q-axis in the circumferential direction and has a shorter circumferential width than that of the groove portion; the groove portion includes:
a first side surface which is formed on the one side in the circumferential direction from the protruding portion; and
a second side surface which is formed on the other side in the circumferential direction from the protruding portion;
the first side surface of the groove portion is formed to face the second end portion of the magnet insertion hole provided in each of the plurality of magnetic pole portions located on the one side of the q-axis in the circumferential direction;
the second side surface of the groove portion is formed to face the first end portion of the magnet insertion hole provided in each of the plurality of magnetic pole portions located on the other side of the q-axis in the circumferential direction;
a first rib is formed between the first end portion of the magnet insertion hole and the second side surface of the groove portion, the first end portion of the magnet insertion hole being provided in each of the plurality of magnetic pole portions located on the other side of the q-axis in the circumferential direction;
a second rib is formed between the second end portion of the magnet insertion hole and the first side surface of the groove portion, the second end portion of the magnet insertion hole being provided in each of the magnetic pole portions located on the one side in the circumferential direction relative to the q-axis;
the protruding portion is provided with a pair of flange portions which protrude toward the one side in the circumferential direction and the other side in the circumferential direction from a base end portion connected to the groove portion on the radially inner side of the protruding portion; and
an outer circumferential surface on the radially outer side of a tip end portion on the radially outer side of the protruding portion and outer circumferential surfaces on the radially outer side of the pair of flange portions have an arc shape having the same center and the same diameter as the outer circumferential surface of the rotor core.

According to the present disclosure, a decrease in a q-axis magnetic flux can he prevented so as to prevent a decrease in output torque of the rotary electric machine, and a fastening load received from the ring member can be received in a dispersed manner by the outer circumferential surface of the tip end portion of the protruding portion and the outer circumferential surfaces of the pair of flange portions, thereby reducing concentration of stress on a specific portion of the rotor core.

### BRIEF DESCRIPTION OF DRAWINGS

FIG. 1 is a front view of a rotary electric machine according to an embodiment of the present disclosure as viewed from one side in an axial direction.

FIG. 2 is a perspective view of a rotor core and a ring member of the rotary electric machine illustrated in FIG. 1.

FIG. 3 is an enlarged view of a main part of a rotor of the rotary electric machine illustrated in FIG. 1.

FIG. 4 is an enlarged view of a main part of FIG. 1.

### DESCRIPTION OF EMBODIMENTS

Hereinafter, an embodiment of a rotor of a rotary electric machine and the rotary electric machine including the rotor according to the present disclosure will be described with reference to accompanying drawings. The drawings are viewed in directions of reference numerals.

<Overall Configuration of Rotary Electric Machine>

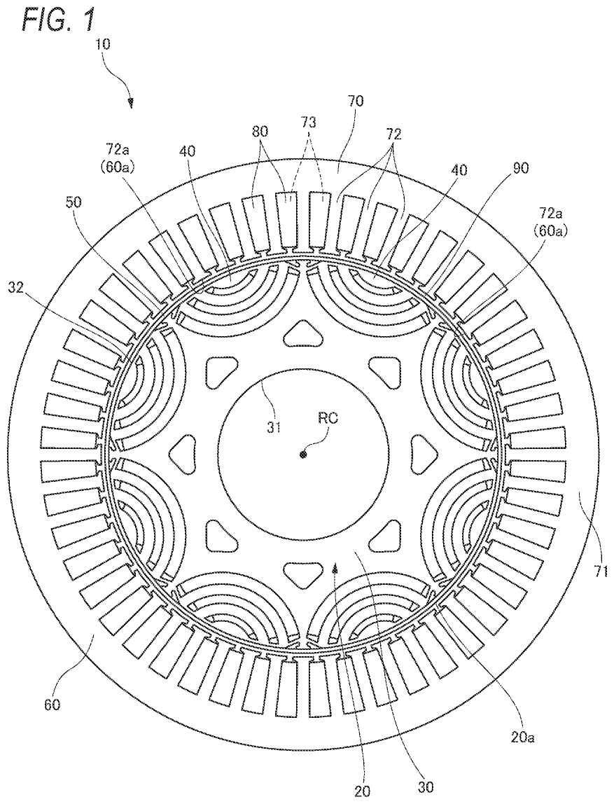

As illustrated in FIG. 1, a rotary electric machine 10 according to the present embodiment includes: a substantially annular rotor 20 which rotates with a rotation axis RC serving as a rotation axis thereof and is centered on the rotation axis RC; and a stator 60 which is arranged to surround an outer circumferential surface 20a of the rotor 20.

In the present specification and the like, unless otherwise specified, the terms “axial direction”, “radial direction”, and “circumferential direction” refer to directions based on the rotation axis RC of the rotor 20. In addition, an axially inner side refers to the side of a center of the rotary electric machine 10 in the axial direction, and an axially outer side refers to a side away from the center of the rotary electric machine 10 in the axial direction.

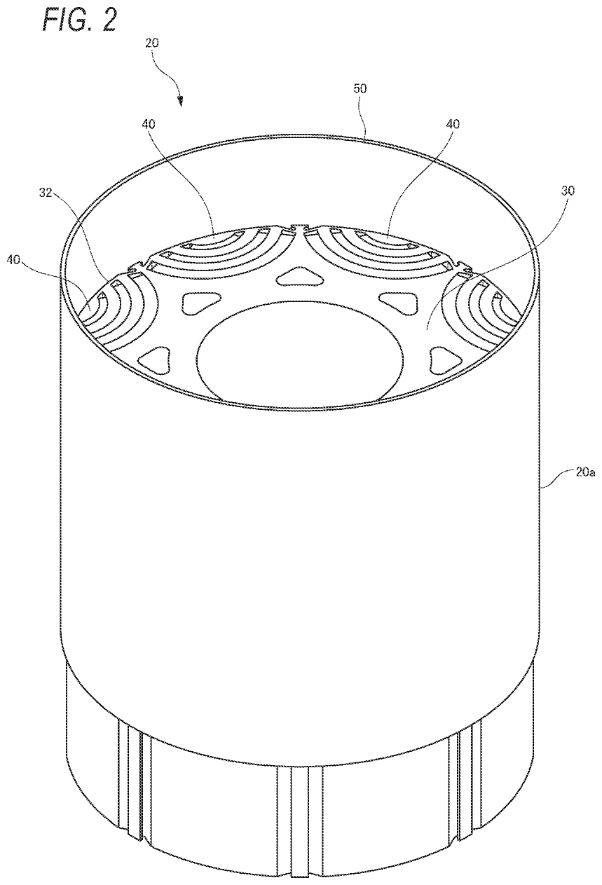

As illustrated in FIGS. 1 and 2, the rotor 20 includes: a rotor core 30 which has a substantially annular shape centered on the rotation axis RC in which a plurality of magnetic pole portions 40 are formed at predetermined intervals in the circumferential direction; and a ring member 50 having a substantially annular shape and covering an outer circumferential surface 32 of the rotor core 30. In the present embodiment, eight magnetic pole portions 40 are formed in the rotor core 30 at predetermined intervals in the circumferential direction. The rotor core 30 is fastened and fixed to the ring member 50 by press fitting, shrink fitting, cool fitting, or the like. The outer circumferential surface 20a of the rotor 20 is configured by an outer circumferential surface of the ring member 50. The ring member 50 is formed of a high-strength non-magnetic material, and is formed of, for example, carbon fiber reinforced plastics (CFRP).

The rotor core 30 is formed by laminating a plurality of substantially annular electromagnetic steel plates having the same shape in the axial direction. When viewed in the axial direction, the rotor core 30 includes: a substantially circular inner circumferential surface 31 which is concentric with the rotation axis RC; and the substantially circular outer circumferential surface 32 which is concentric with the rotation axis RC and has a larger diameter than the inner circumferential surface 31. A rotor shaft (not illustrated) is fastened and fixed to the inner circumferential surface 31 by press fitting, shrink fitting, cool fitting, or the like.

Therefore, the rotor core 30 according to the present embodiment receives a radially outward fastening load input from the rotor shaft to the inner circumferential surface 31, a radially outward centrifugal force load generated at the rotor core 30 due to rotation of the rotor 20, and, meanwhile, receives a radially inward fastening load input from the ring member 50 to the outer circumferential surface 32. As a result, stress generated on the rotor core 30 due to the radially outward fastening load input from the rotor shaft to the inner circumferential surface 31 and the radially outward centrifugal force load generated at the rotor core 30 due to the rotation of the rotor 20 is offset by the radially inward fastening load input from the ring member 50 to the outer circumferential surface 32, and thus the rotor core 30 can be prevented from being deformed by the fastening load received from the rotor shaft to the inner circumferential surface 31 of the rotor core 30 and the centrifugal force load generated at the rotor core 30 due to the rotation of the rotor 20.

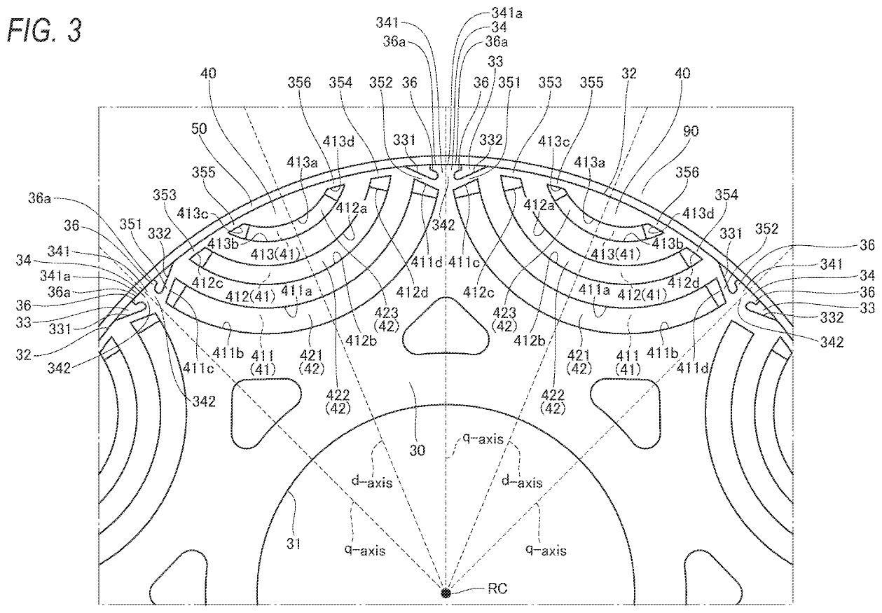

As illustrated in FIG. 3, each magnetic pole portion 40 includes: a magnet insertion hole 41 which penetrates the rotor core 30 in the axial direction; and a permanent magnet 42 which is inserted into the magnet insertion hole 41.

A central axis of each magnetic pole portion 40 which connects the rotation axis RC and a center of each magnetic pole portion 40 is referred to as a d-axis (d-axis in the drawing) and an axis which is separated by an electric angle of 90 degrees relative to the d-axis is referred to as a q-axis (q-axis in the drawing). When viewed from the axial direction, the magnet insertion hole 41 of each magnetic pole portion 40 includes: a first magnet insertion hole 411 which is arranged at a position intersecting the d-axis, has a shape symmetrical relative to the d-axis, and has a substantially arc shape protruding radially inward; a second magnet insertion hole 412 which is arranged radially outward of the first magnet insertion hole 411, has a shape symmetrical relative to the d-axis, and has a substantially arc shape protruding radially inward; and a third magnet insertion hole 413 which is arranged radially outward of the second magnet insertion hole 412, has a shape symmetrical relative to the d-axis, and has a substantially arc shape protruding radially inward.

The permanent magnet 42 of each magnetic pole portion 40 includes: a substantially arc-shaped first permanent magnet 421 which is inserted into the first magnet insertion hole 411 and is arranged to protrude radially inward; a substantially arc-shaped second permanent magnet 422 which is inserted into the second magnet insertion hole 412 and is arranged to protrude radially inward; and a substantially arc-shaped third permanent magnet 423 which is inserted into the third magnet insertion hole 413 and is arranged to protrude radially inward.

The permanent magnet 42 of each magnetic pole portion 40, that is, the first permanent magnet 421, the second permanent magnet 422, and the third permanent magnet 423 are magnetized in the radial direction. In addition, the permanent magnets 42, that is, the first permanent magnet 421, the second permanent magnet 422, and the third permanent magnet 423 are arranged such that magnetization directions of adjacent magnetic pole portions 40 are different from each other, and magnetization directions of the magnetic pole portions 40 are alternately different from each other in the circumferential direction.

When viewed in the axial direction, the first magnet insertion hole 411 includes: an outer-diameter-side wall surface 411a which has a substantially arc shape whose arc center is located on the d-axis on a radially outer side from the rotor core 30 and extends in the circumferential direction symmetrically relative to the d-axis; an inner-diameter-side wall surface 411b which has a substantially arc shape whose arc center is the same as the outer-diameter-side wall surface 411a, faces the outer-diameter-side wall surface 411a on a radially inner side, and extends in the circumferential direction symmetrically relative to the d-axis; a first end portion 411c which connects an end portion on one side in the circumferential direction (counterclockwise side in FIG. 3) of the outer-diameter-side wall surface 411a and an end portion on the one side in the circumferential direction of the inner-diameter-side wall surface 411b; and a second end portion 411d which connects an end portion on the other side in the circumferential direction (clockwise side in FIG. 3) of the outer-diameter-side wall surface 411a and an end portion on the other side in the circumferential direction of the inner-diameter-side wall surface 411b. The outer-diameter-side wall surface 411a and the inner-diameter-side wall surface 411b of the first magnet insertion hole 411 extend in a substantially arc shape such that the end portion on the one side in the circumferential direction and the end portion on the other side in the circumferential direction are located in the vicinity of the outer circumferential surface 32 of the rotor core 30.

When viewed in the axial direction, the second magnet insertion hole 412 includes: an outer-diameter-side wall surface 412a which has a substantially arc shape whose arc center is located on the d-axis on a radially outer side from the rotor core 30 and extends in the circumferential direction symmetrically relative to the d-axis; an inner-diameter-side wall surface 412b which has a substantially arc shape whose arc center is the same as the outer-diameter-side wall surface 412a, faces the outer-diameter-side wall surface 412a on a radially inner side, and extends in the circumferential direction symmetrically relative to the d-axis; a first end portion 412c which connects an end portion on one side in the circumferential direction (counterclockwise side in FIG. 3) of the outer-diameter-side wall surface 412a and an end portion on the one side in the circumferential direction of the inner-diameter-side wall surface 412b; and a second end portion 412d which connects an end portion on the other side in the circumferential direction (clockwise side in FIG. 3) of the outer-diameter-side wall surface 412a and an end portion on the other side in the circumferential direction of the inner-diameter-side wall surface 412b. The outer-diameter-side wall surface 412a and the inner-diameter-side wall surface 412b of the second magnet insertion hole 412 extend in a substantially arc shape such that the end portion on the one side in the circumferential direction and the end portion on the other side in the circumferential direction are located in the vicinity of the outer circumferential surface 32 of the rotor core 30.

When viewed in the axial direction, the third magnet insertion hole 413 includes: an outer-diameter-side wall surface 413a which has a substantially arc shape whose arc center is located on the d-axis on a radially outer side from the rotor core 30 and extends in the circumferential direction symmetrically relative to the d-axis; an inner-diameter-side wall surface 413b which has a substantially arc shape whose arc center is the same as the outer-diameter-side wall surface 413a, faces the outer-diameter-side wall surface 413a on a radially inner side, and extends in the circumferential direction symmetrically relative to the d-axis; a first end portion 413c which connects an end portion on one side in the circumferential direction (counterclockwise side in FIG. 3) of the outer-diameter-side wall surface 413a and an end portion on the one side in the circumferential direction of the inner-diameter-side wall surface 413b; and a second end portion 413d which connects an end portion on the other side in the circumferential direction (clockwise side in FIG. 3) of the outer-diameter-side wall surface 413a and an end portion on the other side in the circumferential direction of the inner-diameter-side wall surface 413b. The outer-diameter-side wall surface 413a and the inner-diameter-side wall surface 413b of the second magnet insertion hole 413 extend in a substantially arc shape such that the end portion on the one side in the circumferential direction and the end portion on the other side in the circumferential direction are located in the vicinity of the outer circumferential surface 32 of the rotor core 30.

The first permanent magnet 421 inserted into the first magnet insertion hole 411 extends in the circumferential direction from the vicinity of the first end portion 411c of the first magnet insertion hole 411 to the vicinity of the second end portion 411d so as to intersect the d-axis and he substantially symmetrical relative to the d-axis when viewed in the axial direction.

The second permanent magnet 422 inserted into the second magnet insertion hole 412 extends in the circumferential direction from the vicinity of the first end portion 412c of the second magnet insertion hole 412 to the vicinity of the second end portion 412d so as to intersect the d-axis and he substantially symmetrical relative to the d-axis when viewed in the axial direction.

The third permanent magnet 423 inserted into the third magnet insertion hole 413 extends in the circumferential direction from the vicinity of the first end portion 413c of the third magnet insertion hole 413 to the vicinity of the second end portion 413d so as to intersect the d-axis and be substantially symmetrical relative to the d-axis when viewed in the axial direction.

The outer circumferential surface 32 of the rotor core 30 includes: a groove portion 33 which is recessed radially inward and extends in the axial direction at a position overlapping the q-axis in the circumferential direction; and a protruding portion 34 which protrudes radially outward from the groove portion 33 at a position overlapping the q-axis in the circumferential direction and has a shorter circumferential width than that of the groove portion 33. Therefore, the groove portion 33 includes: a first side surface 331 which is formed on the one side (counterclockwise side in FIG. 3) in the circumferential direction from the protruding portion 34; and a second side surface 332 which is formed on the other side (clockwise side in FIG. 3) in the circumferential direction from the protruding portion 34.

The protruding portion 34 includes: a tip end portion 341 which is an end portion on a radially outer side; and a base end portion 342 which is an end portion on a radially inner side and is connected to the groove portion 33.

The protruding portion 34 is provided with a pair of flange portions 36 which protrude toward the one side (counterclockwise side in FIG. 3) in the circumferential direction and the other side (clockwise side in FIG. 3) in the circumferential direction from the base end portion 342 of the protruding portion 34.

An outer circumferential surface 341a of the tip end portion 341 of the protruding portion 34 on the radially outer side and outer circumferential surfaces 36a of the pair of flange portions 36 on the radially outer side have an arc shape having the same center and the same diameter as the outer circumferential surface 32 of the rotor core 30.

The first side surface 331 of the groove portion 33 is formed so as to face the second end portion 411d of the first magnet insertion hole 411 provided in the magnetic pole portion 40 located on the one side (counterclockwise side in FIG. 3) of the q-axis in the circumferential direction. The second side surface 332 of the groove portion 33 is formed so as to face the first end portion 411c of the first magnet insertion hole 411 provided in the magnetic pole portion 40 located on the other side (clockwise side in FIG. 3) of the q-axis in the circumferential direction.

A first rib 351 is formed between the first end portion 411c of the first magnet insertion hole 411 provided in the magnetic pole portion 40 located on the other side (clockwise side in FIG. 3) of the q-axis in the circumferential direction and the second side surface 332 of the groove portion 33. A second rib 352 is formed between the second end portion 411 d of the first magnet insertion hole 411 provided in the magnetic pole portion 40 located on the one side (counterclockwise side in FIG. 3) of the q-axis in the circumferential direction and the first side surface 331 of the groove portion 33.

A third rib 353 is formed between the first end portion 412c of the second magnet insertion hole 412 and the outer circumferential surface 32 of the rotor core 30. A fourth rib 354 is formed between the second end portion 412d of the second magnet insertion hole 412 and the outer circumferential surface 32 of the rotor core 30.

A fifth rib 355 is formed between the first end portion 413c of the third magnet insertion hole 413 and the outer circumferential surface 32 of the rotor core 30. A sixth rib 356 is formed between the second end portion 413d of the third magnet insertion hole 413 and the outer circumferential surface 32 of the rotor core 30.

As the first rib 351 and the second rib 352 of the rotor core 30 become thinner, a wraparound magnetic flux circulating in the rotor core 30 through the first rib 351 and the second rib 352 is reduced, and thus output torque of the rotary electric machine 10 is improved. Similarly, as the third to sixth ribs 353 to 356 become thinner, the wraparound magnetic flux circulating in the rotor core 30 through the third rib 353 and the fourth rib 354 is reduced, and thus the output torque of the rotary electric machine 10 is improved.

On the other hand, as the first rib 351 and the second rib 352 of the rotor core 30 become thinner, strength thereof is lowered, and deformation is likely to occur due to the fastening load received from the rotor shaft to the inner circumferential surface 31 of the rotor core 30 and the centrifugal force load generated at the rotor core 30 due to the rotation of the rotor 20. Similarly, as the third to sixth ribs 353 to 356 of the rotor core 30 become thinner, strength thereof is lowered, and deformation is likely to occur due to the fastening load received from the rotor shaft to the inner circumferential surface 31 of the rotor core 30 and the centrifugal force load of the rotor core 30 due to the rotation of the rotor 20.

However, in the present embodiment, since the rotor core 30 is fastened and fixed to the ring member 50, the outer circumferential surface 32 of the rotor core 30 is abutted against the ring member 50. Therefore, even when the first to sixth ribs 351 to 356 are thinned, the ring member 50 can prevent the first to sixth ribs 351 to 356 from being deformed radially outward due to the fastening load received from the rotor shaft to the inner circumferential surface 31 of the rotor core 30 and the centrifugal force load generated at the rotor core 30 due to the rotation of the rotor 20.

As a result, the output torque of the rotary electric machine 10 can be improved while preventing the first to sixth ribs 351 to 356 from being deformed due to the fastening load received from the rotor shaft to the inner circumferential surface 31 of the rotor core 30 and the centrifugal force load generated at the rotor core 30 due to the rotation of the rotor 20.

However, if the groove portion 33 which is recessed radially inward and extends in the axial direction at the position overlapping the q-axis in the circumferential direction of the outer circumferential surface 32 of the rotor core 30 is provided while the protruding portion 34 is not provided, a radial gap between the rotor core 30 and the stator 60 is increased in the groove portion 33 which serves as a q-axis magnetic path, and magnetic resistance of the q-axis magnetic path is increased as the radial gap between the rotor core 30 and the stator 60 is increased, so that a q-axis magnetic flux is decreased and the output torque of the rotary electric machine 10 is decreased.

If the groove portion 33 which is recessed radially inward and extends in the axial direction at the position overlapping the q-axis in the circumferential direction of the outer circumferential surface 32 of the rotor core 30 is provided while the protruding portion 34 is not provided, stress is concentrated on a circumferential end portion 33a of the groove portion 33 due to the fastening load received by the rotor core 30 from the ring member 50.

In the present embodiment, since the protruding portion 34 which protrudes radially outward from the groove portion 33 is provided at the position overlapping the q-axis in the circumferential direction, the decrease in the q-axis magnetic flux can be prevented and thus the decrease in the output torque of the rotary electric machine 10 can be prevented.

On the other hand, if the protruding portion 34 which protrudes radially outward from the groove portion 33 at the position overlapping the q-axis in the circumferential direction is provided while the pair of flange portions 36 are not provided, since the outer circumferential surface 341a of the tip end portion 341 of the protruding portion 34 on the radially outer side has the arc shape having the same center and the same diameter as the outer circumferential surface 32 of the rotor core 30, the outer circumferential surface 341a of the tip end portion 341 of the protruding portion 34 is abutted against the ring member 50, the protruding portion 34 receives the fastening load from the ring member 50, and stress is concentrated on the tip end portion 341 of the protruding portion 34.

In the present embodiment, the protruding portion 34 is provided with the pair of flange portions 36 which protrude to the one side (counterclockwise side in FIG. 3) in the circumferential direction and the other side (clockwise side in FIG. 3) in the circumferential direction while the outer circumferential surface 341a of the tip end portion 341 of the protruding portion 34 and the outer circumferential surfaces 36a of the pair of flange portions 36 on the radially outer side have the arc shape having the same center and the same diameter as the outer circumferential surface 32 of the rotor core 30, so that the outer circumferential surfaces 36a of the pair of flange portions 36 are abutted against the ring member 50 in addition to the outer circumferential surface 341a of the tip end portion 341 of the protruding portion 34. As a result, the fastening load received from the ring member 50 can be received in a dispersed manner by the outer circumferential surface 341a of the tip end portion 341 of the protruding portion 34 and the outer circumferential surfaces 36a of the pair of flange portions 36, and thus the concentration of stress on the tip end portion 341 of the protruding portion 34 can be reduced.

In this way, the rotor 20 of the present embodiment can receive the fastening load received from the ring member 50 in the dispersed manner while preventing the q-axis magnetic flux from decreasing and preventing the output torque of the rotary electric machine 10 from decreasing, and can reduce the concentration of stress on a specific portion of the rotor core 30.

Further, in the present embodiment, the first magnet insertion hole 411 extends in the circumferential direction so as to intersect the d-axis, the first end portion 411c faces the second side surface 332 of the groove portion 33, and the second end portion 411d faces the first side surface 331 of the groove portion 33. The first magnet insertion hole 411 does not include any intermediate rib which connects the outer-diameter-side wall surface 411a and the inner-diameter-side wall surface 411b between the first end portion 411c and the second end portion 411d.

As a result, stress can be prevented from being concentrated on the intermediate rib due to the fastening load received from the rotor shaft to the inner circumferential surface 31 of the rotor core 30 and the centrifugal force load generated at the rotor core 30 due to the rotation of the rotor 20. Further, generation of a wraparound magnetic flux circulating in the rotor core 30 through the intermediate rib can be prevented, so that the output torque of the rotary electric machine 10 is further improved.

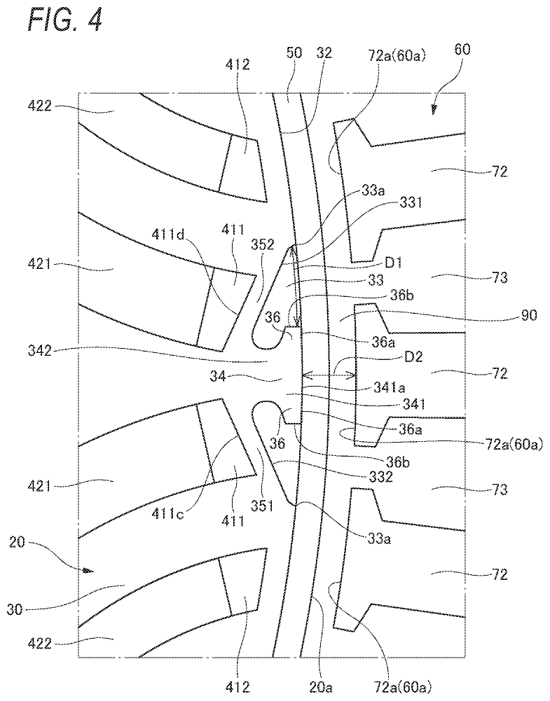

Referring back to FIG. 1, the stator 60 is arranged so as to face the outer circumferential surface 20a of the rotor 20 at a predetermined interval in the radial direction. Therefore, a gap portion 90 is formed between the outer circumferential surface 20a of the rotor 20 and an inner circumferential surface 60a of the stator 60 in the radial direction (see FIG. 4).

The stator 60 includes a substantially annular stator core 70 arranged at a predetermined interval in the radial direction from the outer circumferential surface 20a of the rotor 20, and a coil 80 attached to the stator core 70.

The stator core 70 is formed by laminating a plurality of substantially annular electromagnetic steel plates having the same shape in the axial direction.

The stator core 70 includes a substantially annular stator yoke portion 71, and a plurality of tooth portions 72 which protrude from an inner circumferential surface of the stator yoke portion 71 toward a center in the radial direction. The plurality of tooth portions 72 are arranged at equal intervals along the circumferential direction. In the present embodiment, forty-eight tooth portions 72 are arranged at equal intervals along the circumferential direction of the stator core 70. A slot portion 73 is formed between adjacent tooth portions 72 in the circumferential direction of the stator core 70. A plurality of the slat portions 73 are formed at equal intervals along the circumferential direction. In the present embodiment, forty-eight slot portions 73 are arranged at equal intervals along the circumferential direction.

A tip end surface 72a of each tooth portion 72 on the radially inner side has an arc shape centered on the rotation axis RC when viewed in the axial direction. The inner circumferential surface 60a of the stator 60 is configured by the tip end surface 72a of each tooth portion 72.

The coil 80 is inserted into each slot portion 73 of the stator core 70, and is configured with a U-phase winding, a V-phase winding, and a W-phase winding which are wound around the tooth portions 72.

As illustrated in FIG. 4, when viewed in the axial direction, a circumferential distance D1 between circumferential protruding end portions 36b of the pair of flange portions 36 provided on the tip end portion 341 of the protruding portion 34 of the rotor core 30 and the circumferential end portion 33a of the groove portion 33 is longer than a radial distance D2 between the outer circumferential surface 341a of the tip end portion 341 of the protruding portion 34 of the rotor core 30 and the tip end surface 72a of the tooth portion 72 of the stator 60.

As a result, the circumferential protruding end portions 36b of the flange portions 36 and the circumferential end portion 33a of the groove portion 33 are short-circuited, and thus the wraparound magnetic flux circulating in the rotor core 30 can be reduced.

Therefore, the fastening load received from the ring member 50 can be received in a dispersed manner by the outer circumferential surface 341a of the tip end portion 341 of the protruding portion 34 and the outer circumferential surfaces 36a of the pair of flange portions 36, concentration of stress on the tip end portion 341 of the protruding portion 34 can be reduced while the wraparound magnetic flux circulating in the rotor core 30 can be reduced. by short-circuiting the circumferential protruding end portions 36b of the flange portions 36 and the circumferential end portion 33a of the groove portion 33, so that the output torque of the rotary electric machine 10 can be further improved while reducing the concentration of stress on the tip end portion 341 of the protruding portion 34.

Although one embodiment of the present disclosure has been described above with reference to the accompanying drawings, it is needless to say that the present disclosure is not limited to such an embodiment. It will be apparent to those skilled in the art that various changes and modifications may be conceived within the scope of the claims. It is also understood that the various changes and modifications belong to the technical scope of the present invention. Constituent elements in the embodiments described above may be combined freely within a range not departing from a spirit of the invention.

For example, although the rotor core 30 is provided with the second magnet insertion hole 412 and the third magnet insertion hole 413 on the radially outer side of the first magnet insertion hole 411, and the second permanent magnet 422 and the third permanent magnet 423 are inserted therein in the present embodiment, the rotor 20 may not include the second magnet insertion hole 412, the third magnet insertion hole 413, the second permanent magnet 422 and the third permanent magnet 423. Moreover, the rotor 20 may further include a magnet insertion hole and a permanent magnet on the radially outer side of the first magnet insertion hole 411 in addition to the second magnet insertion hole 412, the third magnet insertion hole 413, the second permanent magnet 422 and the third permanent magnet 423.

For example, although the first magnet insertion hole 411 is arranged at the position intersecting the d-axis when viewed from the axial direction, has the shape symmetrical relative to the d-axis, and has the substantially arc shape which protrudes radially inward in the present embodiment, a pair of the first magnet insertion holes 411 may be respectively provided on the one side of the d-axis in the circumferential direction and the other side of the d-axis in the circumferential direction when viewed from the axial direction, and the pair of first magnet insertion holes 411 may have positions and shapes symmetrical relative to the d-axis. In addition, three first magnet insertion holes 411 may be provided side by side in the circumferential direction at the position intersecting the d-axis when viewed in the axial direction, the one side in the circumferential direction from the d-axis, and the other side in the circumferential direction from the d-axis, and the three first magnet insertion holes 411 may have positions and shapes symmetrical relative to the d-axis.

At least the following matters are described in the present specification. Although corresponding elements and the like in the above embodiment are shown in parentheses as an example, the present disclosure is not limited thereto.

(1) A rotor (rotor 20) of a rotary electric machine includes:

a rotor core (rotor core 30) having a substantially annular shape in which a plurality of magnetic pole portions (magnetic pole portions 40) are formed at predetermined intervals in a circumferential direction; and

a ring member (ring member 50) having a substantially annular shape covering an outer circumferential surface (outer circumferential surface 32) of the rotor core in which:

each of the plurality of magnetic pole portions includes at least one magnet insertion hole (first magnet insertion hole 411) which penetrates the rotor core in an axial direction, and a permanent magnet ((first permanent magnet 421) which is inserted into the magnet insertion hole;

the rotor core is fastened and fixed to the ring member;

a central axis of each of the plurality of magnetic pole portions is a d-axis;

an axis which is separated from the d-axis by an electric angle of 90 degrees is a q-axis; and

when viewed from the axial direction;
the magnet insertion hole provided in each of the plurality of magnetic pole portions includes:
   an outer-diameter-side wall surface (outer-diameter-side wall surface 411a) which extends in the circumferential direction;
   an inner-diameter-side wall surface inner-diameter-side wall surface 411b) which extends in the circumferential direction and faces the outer-diameter-side wall surface on a radially inner side;
   a first end portion (first end portion 411c) which connects an end portion on one side of the outer-diameter-side wall surface in the circumferential direction and an end portion of the inner-diameter-side wall surface on the one side in the circumferential direction; and
   a second end portion (second end portion 411d) which connects an end portion of the outer-diameter-side wall surface on the other side in the circumferential direction and an end portion of the inner-diameter-side wall surface on the other side in the circumferential direction; the outer circumferential surface of the rotor core includes:
   a groove portion (groove portion 33) which is recessed radially inward and extends in the axial direction at a position overlapping the q-axis in the circumferential direction; and
   a protruding portion (protruding portion 34) which protrudes radially outward from the groove portion at a position overlapping the q-axis in the circumferential direction and has a shorter circumferential width than that of the groove portion;
the groove portion includes:
   a first side surface (first side surface 331) which is formed on the one side in the circumferential direction from the protruding portion; and
   a second side surface (second side surface 332) which is formed on the other side in the circumferential direction from the protruding portion;
the first side surface of the groove portion is formed to face the second end portion of the magnet insertion hole provided in each of the plurality of magnetic pole portions located on the one side of the q-axis in the circumferential direction;
the second side surface of the groove portion is formed to face the first end portion of the magnet insertion hole provided in each of the plurality of magnetic pole portions located on the other side of the q-axis in the circumferential direction;
a first rib (first rib 351) is formed between the first end portion of the magnet insertion hole and the second side surface of the groove portion, the first end portion of the magnet insertion hole being provided in each of the magnetic pole portions located on the other side of the q-axis in the circumferential direction;
a second rib (second rib 352) is formed between the second end portion of the magnet insertion hole and the first side surface of the groove portion, the second end portion of the magnet insertion hole being provided in each of the plurality of magnetic pole portions located on the one side of the q-axis in the circumferential direction;
the protruding portion is provided with a pair of flange portions (flange portions 36) which protrude toward the one side in the circumferential direction and the other side in the circumferential direction from a base end portion (base end portion 342) connected to the groove portion on the radially inner side of the protruding portion; and
an outer circumferential surface (outer circumferential surface 341a) on the radially outer side of a tip end portion (tip end portion 341) on the radially outer side of the protruding portion and outer circumferential surfaces (outer circumferential surfaces 36a) on the radially outer side of the pair of flange portions have an arc shape having the same center and the same diameter as the outer circumferential surface of the rotor core.

According to (1), since the protruding portion which protrudes radially outward from the groove portion is provided at the position overlapping the q-axis in the circumferential direction, a decrease in a q-axis magnetic flux can be prevented and thus a decrease in output torque of the rotary electric machine can be prevented.

The protruding portion is provided with the pair of flange portions which protrudes to the one side in the circumferential direction and the other side in the circumferential direction while the outer circumferential surface on the radially outer side of the tip end portion on the radially outer side of the protruding portion and the outer circumferential surfaces on the radially outer side of the pair of flange portions have the arc shape having the same center and the same diameter as the outer circumferential surface of the rotor core, so that the outer circumferential surfaces of the pair of flange portions are abutted against the ring member in addition to the outer circumferential surface of the tip end portion of the protruding portion. As a result, a fastening load received from the ring member can be received in a dispersed manner by the outer circumferential surface of the tip end portion of the protruding portion and the outer circumferential surfaces of the pair of flange portions, and thus concentration of stress on the tip end portion of the protruding portion can be reduced.

In this way, the rotor can receive the fastening load received from the ring member in the dispersed manner while preventing the q-axis magnetic flux from decreasing and preventing the output torque of the rotary electric machine from decreasing, and can reduce concentration of stress on a specific portion of the rotor core.

(2) The rotor of a rotary electric machine according to (1), in which:

when viewed from the axial direction:
the magnet insertion hole which is predetermined and is provided in each of the plurality of magnetic pole portions extends in the circumferential direction to intersect the d-axis;
the first end portion faces the second side surface of the groove portion;
the second end portion faces the first side surface of the groove portion; and
there is no intermediate rib which connects the outer-diameter-side wall surface and the inner-diameter-side wall surface between the first end portion and the second end portion.

According to (2), since there is no intermediate rib which connects the outer-diameter-side wall surface and the inner-diameter-side wall surface between the first end portion and the second end portion, stress can he prevented from being concentrated on the intermediate rib due to the fastening load received from the rotor shaft to the inner circumferential surface of the rotor core and a centrifugal force load generated at the rotor core due to rotation of the rotor. Further, generation of a wraparound magnetic flux circulating in the rotor core through the intermediate rib can be prevented, so that the output torque of the rotary electric machine is further improved.

(3) A rotary electric machine (rotary electric machine 10) includes:

the rotor according to (1) or (2); and

a stator (stator 60) which includes a stator core (stator core 70) arranged at a predetermined interval in the radial direction from the outer circumferential surface of the rotor and a coil (coil 80) attached to the stator core, in which;

the stator core includes:
a plurality of tooth portions (tooth portions 72) which are provided at equal intervals along the circumferential direction and protrude inward in the radial direction; and
a plurality of slot portions (slot portions 73) which are formed between the tooth portions adjacent to each other in the circumferential direction; and

a circumferential distance (circumferential distance D1) between a circumferential protruding end portion (circumferential protruding end portion 36b) of each of the pair of flange portions and a circumferential end portion (circumferential end portion 33a) of the groove portion is longer than a radial distance (radial distance D2) between the outer circumferential surface of the tip end portion of the protruding portion and a lip end surface (tip end surface 72a) on a radially inner side of the tooth portion.

According to (3), since the circumferential distance between the circumferential protruding end portions of the flange portions and the circumferential end portion of the groove portion is longer than the radial distance between the outer circumferential surface of the tip end portion of the protruding portion and the tip end surface of the tooth portion of the stator, the circumferential protruding end portions of the flange portions and the circumferential end portion of the groove portion are short-circuited, and thus the wraparound magnetic flux circulating in the rotor core can be reduced.

As a result, the fastening load received from the ring member can be received in a dispersed manner by the outer circumferential surface of the tip end portion of the protruding portion and the outer circumferential surfaces of the pair of flange portions, concentration of stress on the tip end portion of the protruding portion can be reduced while the wraparound magnetic flux circulating in the rotor core can be reduced by short-circuiting the circumferential protruding end portions of the flange portions and the circumferential end portion of the groove portion, so that the output torque of the rotary electric machine can be further improved while reducing the concentration of stress on the tip end portion of the protruding portion.

What is claimed is:

1. A rotor of a rotary electric machine, comprising:
a rotor core having a substantially annular shape in which a plurality of magnetic pole portions are formed at predetermined intervals in a circumferential direction; and
a ring member having a substantially annular shape and covering an outer circumferential surface of the rotor core, wherein:
each of the plurality of magnetic pole portions includes at least one magnet insertion hole which penetrates the rotor core in an axial direction, and a permanent magnet which is inserted into the magnet insertion hole;
the rotor core is fastened and fixed to the ring member;
a central axis of each of the plurality of magnetic pole portions is a d-axis;
an axis which is separated from the d-axis by an electric angle of 90 degrees is a q-axis; and
when viewed from the axial direction:
the magnet insertion hole provided in each of the plurality of magnetic pole portions includes:
an outer-diameter-side wall surface which extends in the circumferential direction;
an inner-diameter-side wall surface which extends in the circumferential direction and faces the outer-diameter-side wall surface on a radially inner side;
a first end portion which connects an end portion of the outer-diameter-side wall surface on one side in the circumferential direction and an end portion of the inner-diameter-side wall surface on the one side in the circumferential direction; and
a second end portion which connects an end portion of the outer-diameter-side wall surface on the other side in the circumferential direction and an end portion of the inner-diameter-side wall surface on the other side in the circumferential direction;
the outer circumferential surface of the rotor core includes:
a groove portion which is recessed radially inward and extends in the axial direction at a position overlapping the y-axis in the circumferential direction; and
a protruding portion which protrudes radially outward from the groove portion at a position overlapping the q-axis in the circumferential direction and has a shorter circumferential width than that of the groove portion;
the groove portion includes:
a first side surface which is formed on the one side in the circumferential direction from the protruding portion; and
a second side surface which is formed on the other side in the circumferential direction from the protruding portion;
the first side surface of the groove portion is formed to face the second end portion of the magnet insertion hole provided in each of the plurality of magnetic pole portions located on the one side of the q-axis in the circumferential direction;
the second side surface of the groove portion is formed to face the first end portion of the magnet insertion hole provided in each of the plurality of magnetic pole portions located on the other side of the q-axis in the circumferential direction;
a first rib is formed between the first end portion of the magnet insertion hole and the second side surface of the groove portion, the first end portion of the magnet insertion hole being provided in each of the plurality of magnetic pole portions located on the other side of the q-axis in the circumferential direction;
a second rib is formed between the second end portion of the magnet insertion hole and the first side surface of the groove portion, the second end portion of the magnet insertion hole being provided in each of the magnetic pole portions located on the one side in the circumferential direction relative to the q-axis;
the protruding portion is provided with a pair of flange portions which protrude toward the one side in the circumferential direction and the other side in the circumferential direction from a base end portion connected to the groove portion on the radially inner side of the protruding portion; and
an outer circumferential surface on the radially outer side of a tip end portion on the radially outer side of the protruding portion and outer circumferential surfaces on the radially outer side of the pair of flange portions have an arc shape having the same center and the same diameter as the outer circumferential surface of the rotor core.

2. The rotor of a rotary electric machine according to claim 1, wherein:
when viewed from the axial direction:
the magnet insertion hole which is predetermined and is provided in each of the plurality of magnetic pole portions extends in the circumferential direction to intersect the d-axis;
the first end portion faces the second side surface of the groove portion;
the second end portion faces the first side surface of the groove portion; and
there is no intermediate rib which connects the outer-diameter-side wall surface and the inner-diameter-side wall surface between the first end portion and the second end portion.

3. A rotary electric machine comprising:
the rotor according to claim 1; and
a stator which includes a stator core arranged at a predetermined interval in the radial direction from the outer circumferential surface of the rotor, and a coil attached to the stator core, wherein:
the stator core includes:
a plurality of tooth portions which are provided at equal intervals along the circumferential direction and protrude inward in the radial direction; and
a plurality of slot portions which are formed between the tooth portions adjacent to each other in the circumferential direction; and
a circumferential distance between a circumferential protruding end portion of each of the pair of flange portions and a circumferential end portion of the groove portion is longer than a radial distance between the outer circumferential surface of the tip end portion of the protruding portion and a tip end surface on a radially inner side of the tooth portion.
